(19) United States
(12) Patent Application Publication
(10) Pub. No.: US 2026/0149868 A1
(43) Pub. Date: May 28, 2026

(54) ELECTRONIC DEVICE THAT PERFORMS AUTOMATIC PROCESSING BASED ON USER INSTRUCTION, INFORMATION PROCESSING APPARATUS THAT GENERATES AND OUTPUTS APPROPRIATE RESPONSE TO INPUT NATURAL LANGUAGE, SYSTEM, METHOD FOR CONTROLLING ELECTRONIC DEVICE, METHOD FOR CONTROLLING INFORMATION PROCESSING APPARATUS, AND NON-TRANSITORY COMPUTER READABLE MEDIUM

(71) Applicant: CANON KABUSHIKI KAISHA, Tokyo (JP)

(72) Inventor: KEIICHIRO KUBO, Saitama (JP)

(21) Appl. No.: 19/395,770

(22) Filed: Nov. 20, 2025

(30) Foreign Application Priority Data
Nov. 27, 2024 (JP) 2024-206750

(51) Int. Cl. H04N 23/62; G06F 3/12; H04N 23/60

(52) U.S. Cl. CPC H04N 23/62; G06F 3/1204; G06F 3/1254; H04N 23/64

(57) ABSTRACT

An electronic device executes a process according to a setting value and includes one or more processors that execute a program stored in a memory and thereby function as: a first transmission unit that transmits, to a selection unit that selects at least one setting item of the electronic device based on arbitrary text information received as an instruction input by a user, the arbitrary text information and information about the setting item; a first reception unit that receives the setting item from the selection unit; a second transmission unit that transmits, to a determination unit that determines the setting value for executing the process according to the instruction, information about the setting value settable in the setting item; a second reception unit that receives the setting value from the determination unit; and a control unit that performs control to perform the process based on the setting value.

### BACKGROUND

### Field of the Technology

The present disclosure relates to electronic devices that perform automatic processing based on instructions from users.

### Description of the Related Art

In recent years, systems that automatically start processing in response to voice input from users have reached the stage of practical implementation. This technology significantly reduces the necessity for manual operation and enables more intuitive and rapid control of electronic devices. Japanese Patent Laid-Open No. 2022-111133 discloses an image capture instruction method in which, when a user utters a keyword instructing the start of image capturing (e.g., “take a photo”), the voice is recognized by an audio processing unit and is used as a trigger for image capturing.

In the technology described in Japanese Patent Laid-Open No. 2022-111133, voice commands are limited to preliminarily registered phrases, and the user is required to memorize and use specific phrases.

### SUMMARY

The present disclosure has been made in consideration of the above limitations and is directed to an electronic device that controls a process by performing automatic processing based on user instruction that includes an arbitrarily-expressed instruction.

According to an aspect of the present disclosure, there is provided an electronic device that executes a process according to a setting value. The electronic device includes one or more processors that execute a program stored in a memory and thereby function as: a first transmission unit, a first reception unit, a second transmission unit, a second reception unit, and a control unit. The first transmission unit is configured to transmit arbitrary text information received as an instruction input by a user and information about at least one setting item of the electronic device to a selection unit configured to select the at least one setting item of the electronic device based on the arbitrary text information. The first reception unit is configured to receive the setting item from the selection unit. The second transmission unit is configured to transmit information about the setting value settable in the setting item received by the first reception unit to a determination unit configured to determine the setting value for executing the process according to the instruction from the user. The second reception unit is configured to receive the setting value from the determination unit. The control unit is configured to perform control to perform the process based on the setting value received by the second reception unit.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the flow of determining camera settings using a generative artificial intelligence (AI) service in a camera according to a first embodiment.

FIG. 2 illustrates the configuration of the camera according to the first embodiment.

FIG. 3 illustrates a screen example of a smartphone application used in the first embodiment.

FIG. 4A and FIG. 4B each illustrate an example of a prompt for causing the generative AI service to select a camera setting item in the first embodiment.

FIG. 5 is a flowchart of a process for interpreting a message transmitted from the generative AI service in the first embodiment.

FIG. 6A and FIG. 6B each illustrate an example of a prompt for causing the generative AI service to select a camera setting value in the first embodiment.

FIG. 7 illustrates the flow of determining printer settings using a generative AI service in a printer according to a second embodiment.

FIG. 8 illustrates an exemplary screen example for a printer driver installed on a personal-computer (PC) according to the second embodiment.

FIG. 9A and FIG. 9B each illustrate an example of a prompt for causing the generative AI service to select a printer setting item in the second embodiment.

FIG. 10A and FIG. 10B each illustrate an example of a prompt for causing the generative AI service to select a printer setting value in the second embodiment.

### DESCRIPTION OF THE EMBODIMENTS

The present disclosure will be described in detail below based on exemplary embodiments thereof with reference to the appended drawings.

The following embodiments do not limit the disclosure according to the scope of the claims. Although multiple features are described in each embodiment, not all of the features are essential to the disclosure. Moreover, the multiple features may be arbitrarily combined. Furthermore, in the appended drawings, identical or similar components are given the same reference signs, and redundant descriptions are omitted.

The following embodiments of the disclosure relate to a pan-tilt camera (first embodiment) and a printer (second embodiment) as examples of an electronic device. However, the electronic device is not limited to the above. Other examples of the electronic device include home electric appliances, such as a refrigerator and a microwave oven, and office equipment, such as a multifunction device. The first embodiment is directed to a pan-tilt camera as an example of an imaging device, but may be directed to another imaging device. Examples include a digital camera, a video camera, a smartphone, a tablet, a wearable camera, a smartwatch, smart glasses, a web camera, a security camera, a gaming device, a robot, a drone, and a driving recorder. Examples of the printer include an inkjet printer, a laser printer, a 3D printer, a sublimation printer, a portable printer, and a large format printer.

### First Embodiment

This embodiment relates to an example of a process for executing desired image capturing even when an image capture instruction given to a camera by a user (photographer) includes a colloquial expression, such as “shoot with Mr./Ms. A as the center”, “keep shooting the children”, or “take many photos continuously for about five minutes”.

In this embodiment, a method of performing fine control of a device based on an arbitrary natural language expression involves causing a generative artificial intelligence (AI) service to interpret an input natural language and to convert the natural language into a device control command. In this case, when an arbitrary natural-language-based instruction is to be transmitted to the generative AI service, setting items prepared by the device and selection options for setting values in the setting items are added to a prompt. The prompt is provided to the generative AI service so that appropriate device settings can be achieved. However, some generative AI services are fee-based. In particular, when using an application programming interface (API), some adopt a pay-as-you-go charging scheme in which the usage fee is determined according to the number of characters or words in the text. In view of this, it is desirous to suppress cost by reducing the number of text characters in the prompt transmitted to the generative AI service. The generative AI service uses a large language model (LLM). A large language model is a deep learning model constituted by an artificial neural network having a large number of parameters, and generates and outputs an appropriate response to a natural-language-based instruction (prompt).

### Control of Camera Based on Natural Language Instruction

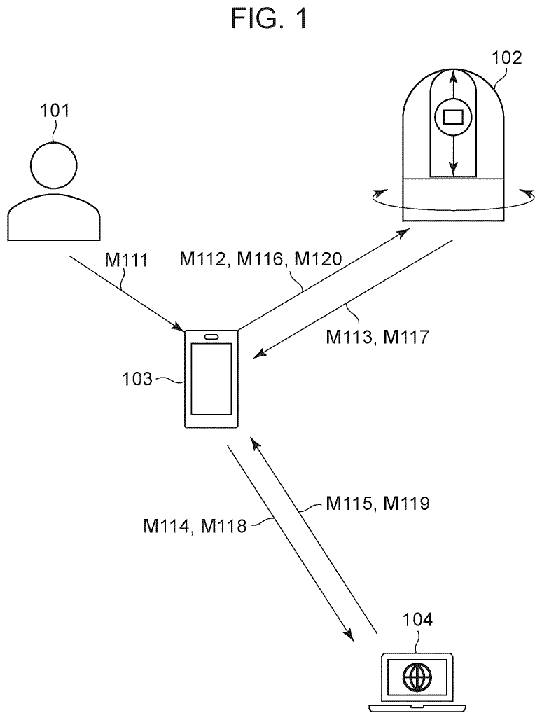

FIG. 1 illustrates the flow for controlling a camera 102 in accordance with a natural language instruction spoken by a user 101. In this embodiment, a smartphone application 103 is used as an information processing apparatus that receives and interprets voice input by the user 101. A configuration where the smartphone application 103 is not used may also be possible if the camera 102 is equipped with an audio reception function as well as functions for speech analysis and text conversion. Reference sign 104 denotes a text generative AI service, which is assumed to be an internet-based generative AI service, such as ChatGPT.

Reference sign M111 denotes a camera-control voice instruction based on voice input by the user 101. An example of such an instruction is “take a photo of the dish so that it appears delicious”. The camera-control voice instruction M111 is first received by the smartphone application 103. The smartphone application 103 interprets the received voice and converts the voice into text data. There are various methods for converting voice into text. In the case of an Android application, a speech recognizer library may be used. A web service that converts voice data into a text string may be used. For example, Speech-to-Text provided by Google LLC (https.//cloud.google.com/speech-to-text) may be used.

Reference sign M112 denotes a camera-setting-item-list request message for making a request for a camera setting item list. The camera-setting-item-list request message is sent from the smartphone application 103 to the camera 102. Upon receiving the camera-control voice instruction M111 from the user 101, the smartphone application 103 transmits the camera-setting-item-list request message M112 to the camera 102.

Reference sign M113 denotes a camera-setting-item-list-request response made by the camera 102 as a response to the camera-setting-item-list request message M112. The details of the response include a camera setting item list to be determined by the text generative AI service 104, and current setting values in the respective camera setting items. The reason for including the current setting values in the response is to meet a request from the user 101 to change the current camera settings, such as “take a photo a little brighter than the previous photo”. The camera setting items included in the camera-setting-item-list request-response M113 may be changed in accordance with the state of the camera or the subject detection status. For example, if the user 101 has manually set the shutter speed, this manual setting may be prioritized, and the shutter speed may be excluded from the camera setting item list.

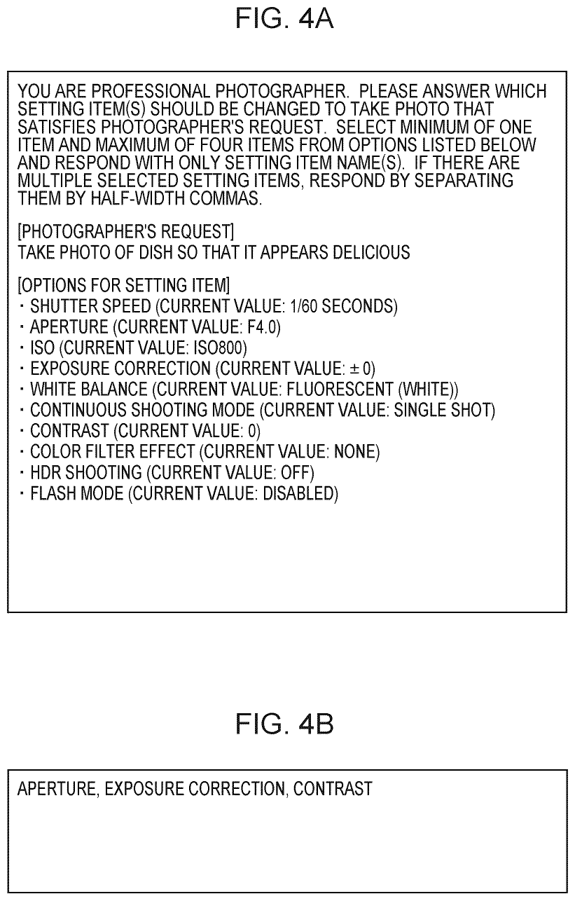

Reference sign M114 denotes a camera-setting-item selection prompt for causing the text generative AI service 104 to select at least one camera setting item from the smartphone application 103. Upon receiving the camera-setting-item-list request response M113 from the camera 102, the smartphone application 103 creates the camera-setting-item selection prompt M114 and transmits the camera-setting-item selection prompt M114 to the text generative AI service 104. As illustrated in FIG. 4A, the camera-setting-item selection prompt M114 includes the camera-control voice instruction M111 and the details of the camera-setting-item-list request response M113.

Reference sign M115 denotes a camera-setting-item selection result (first stage response) from the text generative AI service 104 that has received the camera-setting-item selection prompt M114. As illustrated in FIG. 4B, the text generative AI service 104 returns a selection result of “which setting item(s) should be changed to take a photo that satisfies the photographer's request?”.

Reference sign M116 denotes a camera-setting-value-list request message for making a request to the camera 102 by the smartphone application 103 after receiving the camera-setting-item selection result M115. The smartphone application 103 extracts a camera setting item to be changed from the details of the camera-setting-item selection result M115. Then, the camera-setting-value-list request message M116, which is a request for a camera setting value list settable in the extracted camera setting item, is transmitted to the camera 102.

Reference sign M117 denotes a camera-setting-value-list-request response transmitted from the camera 102 to the smartphone application 103. In response to the camera-setting-value-list request message M116 received from the smartphone application 103, the camera 102 creates a setting value list settable in the target camera setting item and transmits the setting value list to the smartphone application 103.

Reference sign M118 denotes a camera-setting-value determination prompt that the smartphone application 103 having received the camera-setting-value-list-request response M117 provides to the text generative AI service 104 to cause the text generative AI service 104 to determine an appropriate setting value from among the setting value list. The camera-setting-value determination prompt M118 includes the camera-control voice instruction M111, such that the setting value is the one intended by the user 101.

Reference sign M119 denotes a camera-setting-value selection result (second stage response) from the text generative AI service 104 that has received the camera-setting-value determination prompt M118.

Reference sign M120 denotes a camera-setting-value change message that causes the smartphone application 103 to set, in the camera 102, the camera setting value determined in accordance with the camera-setting-value selection result M119 from the text generative AI service 104. Upon receiving this camera-setting-value change message M120, the camera 102 changes the camera settings and performs an image capturing operation.

As mentioned above, the response from the text generative AI service 104 in the first stage includes several camera setting items, whereas the response from the text generative AI service 104 in the second stage includes the setting value in the setting item narrowed down in the first stage. Accordingly, an appropriate setting response can be obtained, and the amount of text being communicated (token quantity) with the text generation AI service 104 can be suppressed.

### Configuration of Camera

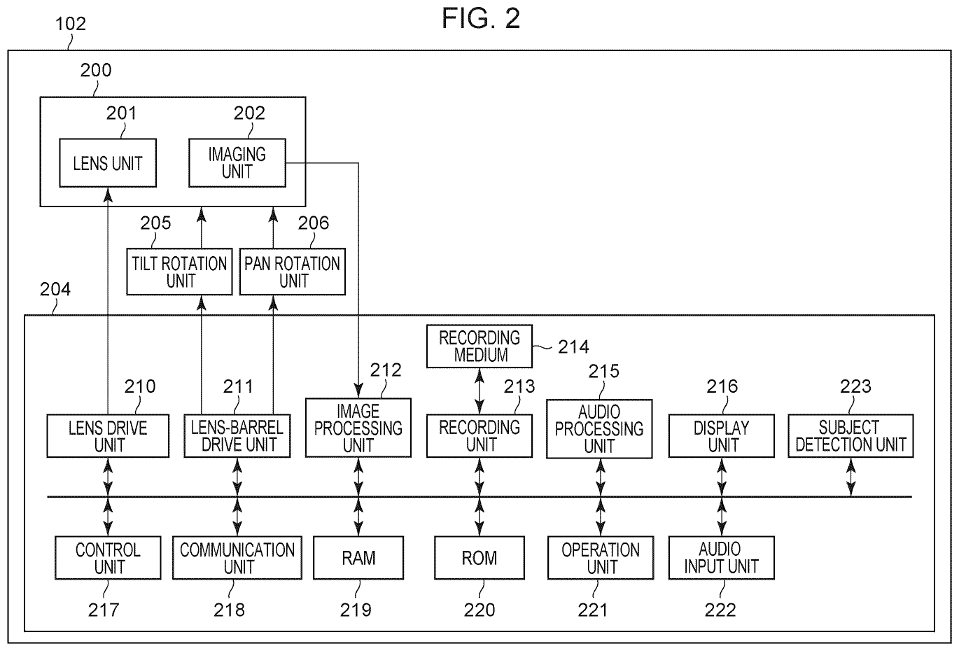

FIG. 2 is a block diagram illustrating the internal configuration of the camera 102 according to this embodiment.

A lens barrel 200 has an optical imaging system and an imaging element that acquires image data based on a light flux from the optical imaging system. The lens barrel 200 is attached to a stationary section (not illustrated) of the camera 102 via a rotationally-drivable rotating mechanism.

A lens unit 201 includes a zoom unit and a focus unit. The zoom unit includes a zoom lens that performs variable magnification. The focus unit includes a lens that performs focusing. The lens unit 201 is driven and controlled by a lens drive unit 210.

An imaging unit 202 includes an imaging element. The imaging element receives a light flux incident via each lens group, and generates charge information according to the light quantity of the light flux as analog image data. The analog image data is output to an image processing unit 212.

A control box 204 includes, for example, an imaging lens group included in the lens barrel 200, as well as a control microcomputer for controlling a tilt rotation unit 205 and a pan rotation unit 206. In this embodiment, the control box 204 is disposed within the stationary section of the camera 102, such that the control box 204 is stationary even when the lens barrel 200 performs pan and tilt driving.

A lens-barrel drive unit 211 drives the tilt rotation unit 205 and the pan rotation unit 206, so as to rotationally drive the lens barrel 200 in a tilt direction and a pan direction. The lens-barrel drive unit 211 is driven and controlled by a control unit 217.

By using an aperture control unit, a sensor gain control unit, and a shutter control unit, which are not illustrated, the camera 102 performs exposure control such that a subject has an appropriate brightness.

The image processing unit 212 converts the analog image data input from the imaging unit 202 into digital image data by analog-to-digital (A/D) conversion. The image processing unit 212 applies image processing, such as distortion correction, white balance adjustment, and color interpolation, to this digital image data, and outputs the image-processed digital image data. The digital image data output from the image processing unit 212 is converted into a recordable format, such as JPEG format, by a recording unit 213, and is transmitted to a random access memory (RAM) 219 and a recording medium 214.

The recording unit 213 records, onto the recording medium 214, for example, a compressed image signal, a compressed audio signal, and other image-capturing-related control data generated by the image processing unit 212 and an audio processing unit 215. If an audio signal is not to be compressively encoded, the control unit 217 transmits the audio signal generated by the audio processing unit 215 and the compressed image signal generated by the image processing unit 212 to the recording unit 213 and causes the recording unit 213 to record the signals onto the recording medium 214.

The recording medium 214 is contained in the camera 102, but may alternatively be a detachable recording medium. Various kinds of data, such as a compressed image signal, a compressed audio signal, and an audio signal generated by the camera 102, can be recorded onto the recording medium 214. Thus, a recording medium having larger available recording volume than a read-only memory (ROM) 220 is employed as the recording medium 214. For example, the recording medium 214 may be of any type, such as a hard disk, an optical disk, a magneto-optical disk, a compact disc recordable (CD-R), a digital versatile disc recordable (DVD-R), a magnetic tape, a nonvolatile semiconductor memory, or a flash memory.

The audio processing unit 215 performs audio-related processing, such as optimizing an input digital audio signal. The audio signal processed by the audio processing unit 215 is transmitted to the RAM 219 by the control unit 217.

A display unit 216 has, for example, a function for outputting visually recognizable information, as in a liquid crystal display (LCD) or a light emitting diode (LED) display.

The control unit 217 includes, for example, a central processing unit (CPU), such as a micro-processing unit (MPU), a memory (such as a dynamic random access memory (DRAM) or a static random access memory (SRAM)), and a nonvolatile memory (electrically erasable programmable ROM (EEPROM)). The control unit 217 executes various kinds of processes (programs) to control the respective blocks of the camera 102 and to control data transfer between the blocks.

A communication unit 218 performs communication with external devices, such as the camera 102 and the smartphone application 103, and transmits and receives data, such as an audio signal, an image signal, a compressed audio signal, a compressed image signal, and a text message. When the camera 102 detects an abnormal state, the communication unit 218 transmits information to each external device to notify the external device of the internal status, such as error information, of the image capturing device. The communication unit 218 includes, for example, a wireless communication module, such as an infrared communication module, a Bluetooth communication module, a wireless local area network (LAN) communication network, a wireless universal serial bus (USB), and/or a global positioning system (GPS) receiver.

The RAM 219 temporarily stores the image signal and the audio signal obtained by the image processing unit 212 and the audio processing unit 215.

The ROM 220 is an electrically erasable and recordable memory, and stores, for example, control constants and programs for operation of the control unit 217.

An operation unit 221 is an input device that receives various kinds of operation performed by the user 101. An example of the operation unit 221 that can be used is a touchscreen or a physical button. For example, a touchscreen is provided on the display surface of the display unit 216 and is integrated with the display unit 216. The operation unit 221 and the display unit 216 may be or do not have to be detachable from the camera 102. The operation unit 221 may be realized as one of applications of a general-purpose computing device, such as a smartphone.

An audio input unit 222 acquires an audio signal around the camera 102 from a microphone provided in the camera 102, performs analog-to-digital conversion on the audio signal, and transmits the audio signal to the audio processing unit 215.

A subject detection unit 223 detects a subject included in a captured image and determines an attribute of the subject. The subject detection unit 223 detects the subject's face and body. In a face detection process, a pattern used for determining the subject's face is preset, and an area that matches the pattern included in the captured image can be detected as a subject's face image.

Furthermore, a reliability level indicating a degree of certainty of the subject's face is calculated at the same time. The reliability level is calculated from, for example, the size of the face region within the image and the degree of matching with the face pattern. With regard to object recognition, an object that matches a preregistered pattern can be similarly recognized.

There is also a method of extracting, from a captured image, a feature of a subject using histograms, such as hue and saturation. In this case, with regard to an image of a subject captured within an imaging angle of view, a distribution derived from histograms, such as hue and saturation, is divided into multiple sections. A process that classifies a captured image for each section is then executed. For example, histograms of multiple color components are created for a captured image, and the image is segmented based on peak-shaped distribution ranges of the histograms. The captured image is then classified into regions belonging to the same combination of segments, and the image region of the subject is recognized. By calculating an evaluation value for each image region of the recognized subject, the image region of the subject with the highest evaluation value can be determined as a main subject region. With the above method, each piece of subject information can be obtained from captured image information.

The subject detection unit 223 further performs an attribute estimation of the detected subject. The attribute estimation involves estimating an attribute from, for example, edge information about the eyes and the mouth in a detected face region and the contour thereof by using a predetermined determination expression. In another embodiment, the method and content are not defined, as in when machine learning is used. In this embodiment, the type of subject, that is, whether the subject is a human, a cat, or another biological classification, is estimated. The attribute to be estimated may be an attribute other than the above, and may include, for example, race, face orientation, face shape, organ and hair color, and presence or absence of a worn item (such as a mask, eyeglasses, sunglasses, eyepatch, hood, or collar).

The image processing unit 212 and the audio processing unit 215 read the image signal and the audio signal temporarily stored in the RAM 219 and respectively encode the image signal and the audio signal, so as to generate a compressed image signal and a compressed audio signal.

### Screen Example of Smartphone Application 103

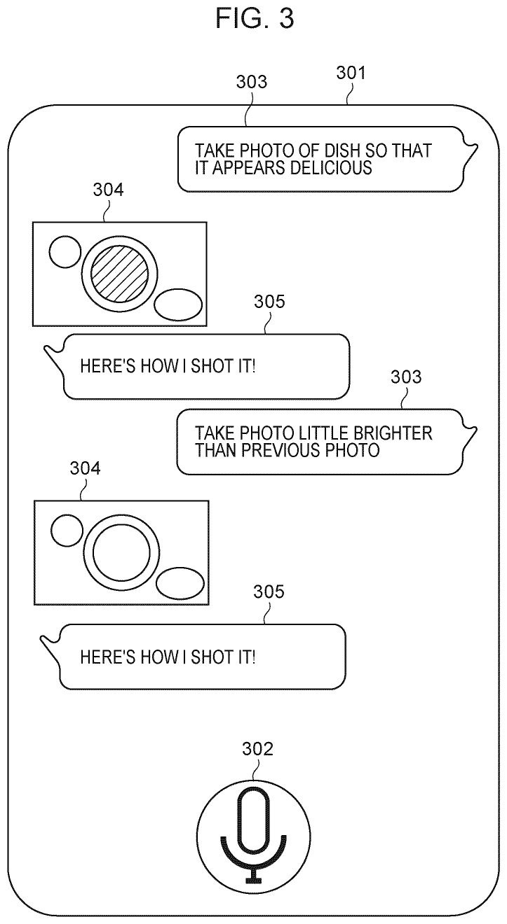

FIG. 3 illustrates a screen example of the smartphone application 103.

A display 301 of a smartphone in which the smartphone application 103 is installed displays items 302 to 305 to be described below.

The item 302 is an audio input button. Tapping on this audio input button 302 changes the current state into an audio input reception state. Tapping the audio input button 302 again terminates the audio input reception state. Voice input from the start to the end of the audio input reception state is regarded as a single image capture instruction.

The item 303 indicates image-capture-instruction voice text obtained as a result of converting the voice of the image capture instruction input to the smartphone application 103 into text.

The item 304 indicates a preview of an image captured using the camera 102 based on the image capture instruction given by the user 101. A most recently captured image from the camera 102 is acquired and is displayed on the screen.

The item 305 indicates a response message from the smartphone application 103 when the image capture instruction is received. The item 305 indicating the response message may display the camera setting values used at the time of image capturing. In this case, the user 101 can check the camera setting values displayed in the item 305 indicating the response message, manually change the camera settings, and take a photo.

Communication between Camera 102 and Smartphone Application 103

The following description relates to communication between the camera 102 and the smartphone application 103. The communication method used is the HTTP protocol. The communication unit 218 of the camera 102 has a function for receiving and interpreting the HTTP protocol.

The exchanges between the camera 102 and the smartphone application 103 are the following five items.
1. The camera-setting-item-list request message M112
2. The camera-setting-item-list-request response M113, which is a response to M112
3. The camera-setting-value-list request message M116
4. The camera-setting-value-list-request response M117, which is a response to M116
5. The camera-setting-value change message M120

First, an example of an HTTP request of the camera-setting-item-list request message M112 is as follows:
GET http://[IP address]:[port number]/cameraapi/camerasettinglist HTTP/1.1

Upon receiving this HTTP request, the camera 102 lists camera setting items to be included in the response message. The camera setting items to be listed may be one or more of setting items existing in the camera 102 instead of all of the setting items. The camera setting items to be included in the response may be narrowed down in advance as a specification of the camera 102. The camera setting items to be included in the response may be narrowed down in accordance with the status detected by the camera 102. For example, if a face is not detected in subject detection, a face-related setting item (such as a setting for preferentially auto-focusing on a face and/or a setting for increasing the exposure of a face) is excluded.

When the camera setting items to be included in the response are determined, the camera 102 creates the camera-setting-item-list-request response M113, which is a response. In this embodiment, the camera setting items to be included in the response are “shutter speed”, “aperture”, “ISO”, “exposure correction”, “white balance”, “continuous shooting mode”, “contrast”, “color filter effect”, “HDR shooting”, and “flash mode”. The response adopts JSON as the data format and has the following content.

```
{
  “Shutter speed”: {
    “Current value”: “1/60”
  },
  “Aperture”: {
    “Current value”: “F4.0”
  },
  “ISO”: {
    “Current value”: “ISO800”
  },
  “Exposure correction”: {
    “Current value”: “±0”
  },
  “White balance”: {
    “Current value”: “Fluorescent (white)”
  },
  “Continuous shooting mode”:{
    “Current value”: “Single shot”
  },
  “Contrast”: {
    “Current value”: “0”
  },
  “Color filter effect”: {
    “Current value”: “None”
  },
  “HDR shooting”: {
    “Current value”: “OFF”
  },
  “Flash mode”: {
    “Current value”: “Disabled”
  }
}
```

An example of an HTTP request of the camera-setting-value-list request message M116 is as follows.

### Shutter Speed

GET http://[IP address]:[port number]/cameraapi/camerasetting/shutterspeed
HTTP/1.1

### White Balance

GET http://[IP address]:[port number]/cameraapi/camerasetting/wb HTTP/1.1

In this embodiment, a uniform resource locator (URL) for an HTTP request is prepared for each camera setting item. The smartphone application 103 extracts a camera setting item to be changed based on the camera-setting-item selection result M115 received from the text generative AI service 104, and uses a URL corresponding to the extracted camera setting item to transmit an HTTP request to the camera 102.

Upon receiving the HTTP request, the camera 102 lists camera setting values to be included in the response message. Similar to when creating the camera-setting-item-list-request response M113, the camera setting values to be listed may be one or more of setting values existing in the camera 102 instead of all of the setting values. For example, in the case of the aperture, even when the camera is capable of stopping down beyond f32, if the aperture is stopped down further than f32, image capturing with appropriate exposure may sometimes be not achievable even by using the shutter speed and ISO sensitivity to their upper limits. In such a case, the camera setting included in the response is limited to f32.

When the camera setting items to be included in the response are determined, the camera 102 creates the camera-setting-value-list-request response M117. In this embodiment, the JSON format is adopted, and the content is as follows.

### Aperture

```
{
    “Current value”: “F4.0”,
  “Setting value list”: [“F1.8”, “F2.0”, “F2.5”, “F2.8”, “F3.5”, “F4.0”,
“F4.5”, “F5.6”, “F8.0”, “F11”, “F16”, “F22”, “F32”]
}
```

An example of an HTTP request of the camera-setting-value change message M120 is as follows.

For a URL used for a request of the camera-setting-value-list request message M116, a PUT command is issued instead of a GET command.

### Shutter Speed

PUT http://[IP address]:[port number]/cameraapi/camerasetting/shutterspeed
HTTP/1.1

The adopted data format of the camera setting value set based on the PUT command is JSON in this embodiment, and the content is as follows:

{
“value”: “1/60”
}

### Example of Camera-Setting-Item Selection Prompt M114

FIG. 4A illustrates an example of the camera-setting-item selection prompt M114 mentioned above. First, the text generative AI service 104 is given the role of providing appropriate camera settings, like a professional photographer, in response to a photographer's request. This response method is limited. Although an upper limit is set on the number of items selectable from the setting items, the upper limit does not necessarily have to be set. The response format with respect to the text generative AI service 104 is also specified in detail. In FIG. 4A, the format is limited so as to be in the form of “item 1, item 2, item 3, . . . ”. This is because, unless the format is limited in this manner, the text generative AI service 104 responds with a natural language expression, thus making it difficult for the smartphone application 103 to interpret the response with a program. Although the camera setting item names are included as-is in the prompt in the example in FIG. 4A, the camera setting item names may be replaced with other terms. For example, the setting item name “highlight luminance tone priority” may be replaced with an expression such as “whiteout reduction”. Furthermore, multiple camera setting items may be replaced with an integrated item. For example, “color temperature” and “contrast” may be combined so as to be changed into an expression such as “warmth of photograph”. However, when a camera setting item is set to a different expression, as mentioned above, the expression of the corresponding camera setting value also has to be changed.

FIG. 4B illustrates an example of the camera-setting-item selection result M115 transmitted from the text generative AI service 104 to the smartphone application 103. The message has the camera setting items “aperture”, “exposure correction”, and “contrast” separated by half-width commas, and is in the format specified by the prompt in FIG. 4A.

### Message-Interpretation Sequence of Smartphone Application 103

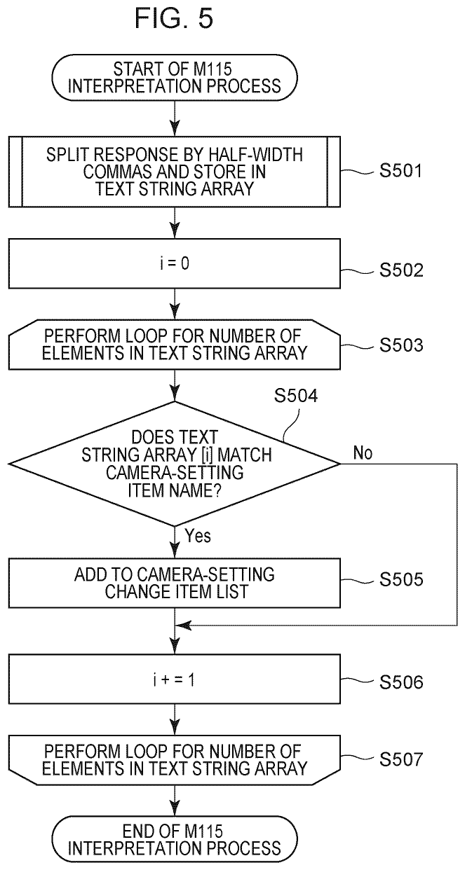

FIG. 5 illustrates a sequence in which the smartphone application 103 receives the camera-setting-item selection result M115 and interprets a message.

In step S501, the text string of the received camera-setting-item selection result M115 is split by half-width commas, and is stored in a text string array. In the example in FIG. 4B, “aperture”, “exposure correction”, and “contrast” are stored in respective elements of the text string array.

Text string array [0] = “aperture”, text string array [1] = “exposure
correction”, text string array [2] = “contrast”

Step S502 involves initializing a count variable i for a loop process of checking whether each text string stored in the text string array exists in the camera setting items.

Step S503 is a start point for the loop process of checking whether each text string stored in the text string array exists in the camera setting items. The loop process is repeated for the number of elements in the text string array. In this embodiment, the loop process is performed three times for i=0, 1, 2.

Step S504 involves checking whether each text string in a text string array [i] is valid as a camera setting item. A list of camera setting items is acquired from the camera by means of the camera-setting-item-list-request response M113. It is checked whether there is a camera setting item list that matches a text string in the text string array [i].

In step S505, if the text string in the text string array [i] is a camera setting item name in step S504, this text string is added to a setting change item list. The setting change item list is retained by the smartphone application 103 in the form of, for example, a variable or database. Based on this information, the camera-setting-value-list request message M116 is created and is transmitted to the camera 102.

In step S506, the loop counter variable i is incremented by one.

In step S507, if the loop counter variable i is incremented by the number of elements in the text string array, the process exits the loop, and the process for interpreting the camera-setting-item selection result M115 ends.

The camera-setting-item selection result M115 is generated by the text generative AI service 104 and may be not in the expected format, may include an invalid cameral setting item, or may be not an appropriate response. If the number of elements in the setting change item list reaches zero or if the number of elements in the text string array is different from the number of elements in the setting change item list, the camera-setting-item selection prompt M114 may be transmitted again to the text generative AI service 104.

### Example of Camera-Setting-Value Determination Prompt M118

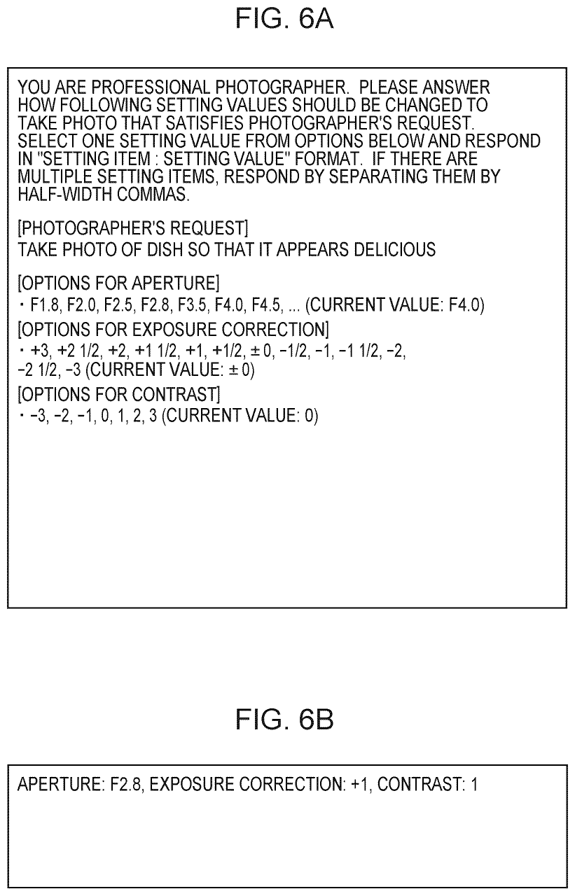

FIG. 6A illustrates an example of the camera-setting-value determination prompt M118 mentioned above. Similar to the camera-setting-item selection prompt M114, the text generative AI service 104 is given the role of providing appropriate camera settings in response to a photographer's request, and the response format is also specified. Furthermore, FIG. 6A includes a list of camera setting values in the camera setting items selected in the camera-setting-item selection result M115.

FIG. 6B illustrates an example of the camera-setting-value selection result M119 transmitted from the text generative AI service 104 to the smartphone application 103. As specified in the prompt in FIG. 6A, a combination of camera setting values in the camera setting items is indicated in the form of “setting item: setting value”, as in “aperture: F2.8”, and the setting items are separated by half-width commas.

### Outline of First Embodiment

Accordingly, in this embodiment, even when an instruction from a user is an ambiguous colloquial expression, an image capturing operation desired by the user can be performed. Moreover, an inquiry to the text generative AI service 104 is set in two stages, namely, a camera setting item and a camera setting value with respect to the selected camera setting item. Accordingly, the text quantity can be reduced, as compared with when an inquiry is made at once by using all combinations of all camera setting items and camera setting values existing in the camera 102.

Although the above description relates to a speech recognition method using the audio input unit 222 and the audio processing unit 215 as a function for inputting an instruction based on arbitrary text information, another configuration may be employed for inputting an arbitrary text instruction. For example, a text string may be directly input by using a text input device, such as a keyboard. Another alternative configuration may receive a text string via, for example, a chat application that operates in another device, such as a smartphone.

### Second Embodiment

A second embodiment relates to a printer as an example.

### Control of Printer Based on Natural Language Instruction

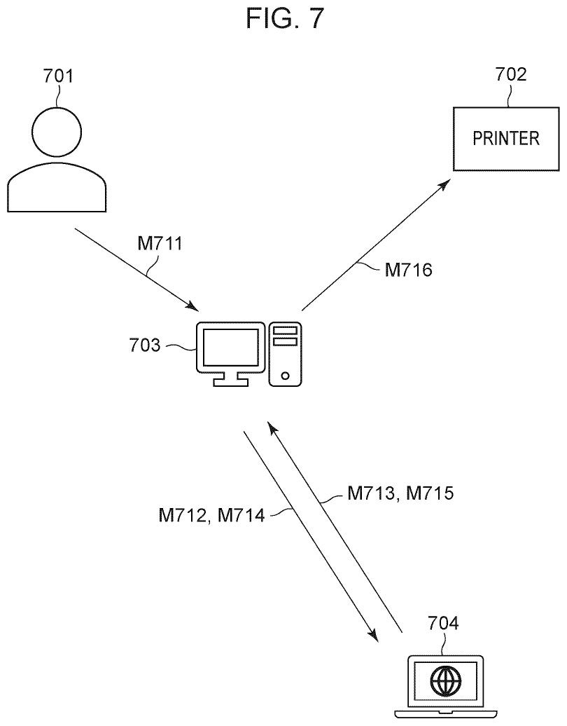

The flow of a method for controlling a printer 702 based on a natural language instruction from a printer user 701 will now be described with reference to FIG. 7. Reference sign 703 denotes a printer driver personal-computer (PC) application equipped with a keyboard-based text input function as well as a setting function and a print instruction function for the printer 702. Reference sign 704 denotes a text generative AI service, which is assumed to be an internet-based service, such as ChatGPT.

Reference sign M711 denotes a printer control instruction given by the printer user 701, and is a natural language instruction input by using a keyboard. An example of such an instruction is “print a New Year's card”.

Reference sign M712 denotes a printer-setting-item determination prompt for determining a printer setting item in the text generative AI service 704 from the printer driver PC application 703. The printer-setting-item determination prompt M712 includes the printer control instruction M711 from the printer user 701 and a printer setting item list. Since the printer driver PC application 703 has ascertained setting items settable in the printer 702, it is possible to create a printer setting item list without having to inquire the printer 702 about the setting items.

Reference sign M713 denotes a printer-setting-item selection result from the text generative AI service 704 that has received the printer-setting-item determination prompt M712.

Reference sign M714 denotes a printer-setting-value determination prompt for causing the printer driver PC application 703 to determine an appropriate setting value from a printer setting value list in the text generative AI service 704. The printer-setting-value determination prompt M714 includes the printer setting value list for printer setting items selected based on the printer-setting-item selection result M713, and the content of the printer control instruction M711. Since the printer driver PC application 703 has knowledge about setting values to be set in the printer 702, the printer driver PC application 703 is capable of creating the printer setting value list.

Reference sign M715 denotes a printer-setting-value selection result from the text generative AI service 704 that has received the printer-setting-value determination prompt M714.

Reference sign M716 denotes a printer print-instruction message for causing the printer driver PC application 703 having received the printer-setting-value selection result M715 from the text generative AI service 704 to set the printer setting values in the printer 702 and to further give a print instruction thereto. Upon receiving the printer print-instruction message M716, the printer 702 changes the printer settings in accordance in the instruction, and performs a printing operation.

### Screen Example of Printer Driver PC Application 703

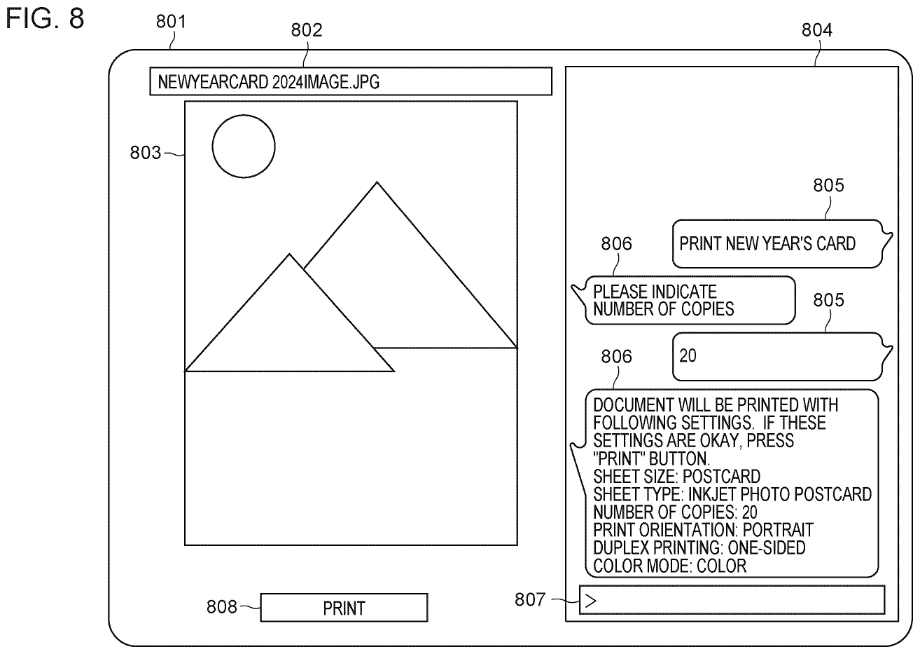

FIG. 8 illustrates a screen example of the printer driver PC application 703.

Items 802 to 808, to be described later, are displayed on a display 801 of a PC in which the printer driver PC application 703 is open.

The item 802 indicates a file name of a print file. This file name may be information indicating what kind of a file is to be printed by being transmitted to the text generative AI service 704.

The item 803 is a print preview screen.

The item 804 is a chat area with the printer driver PC application 703. The chat area includes an instruction input section for the printer user 701, a display section displaying input details, and a reply display section from the printer driver PC application 703.

The item 805 indicates content input by the printer user 701.

The item 806 indicates a message from the printer driver PC application 703.

This is where, when the printer control instruction M711 from the printer user 701 is insufficient, content requesting an additional printer control instruction M711, such as “please indicate the number of copies” is displayed. Alternatively, this is where the determined printer setting items and printer setting values are displayed, so that the printer user 701 can check whether the printer is set to desired settings.

The item 807 is a text input section to be used by the printer user 701 for inputting the printer control instruction M711.

The item 808 is a print button. When the printer user 701 clicks this print button, the printer print-instruction message M716 is transmitted from the printer driver PC application 703 to the printer 702, so that a printing operation starts.

### Example of Printer-Setting-Item Determination Prompt M712

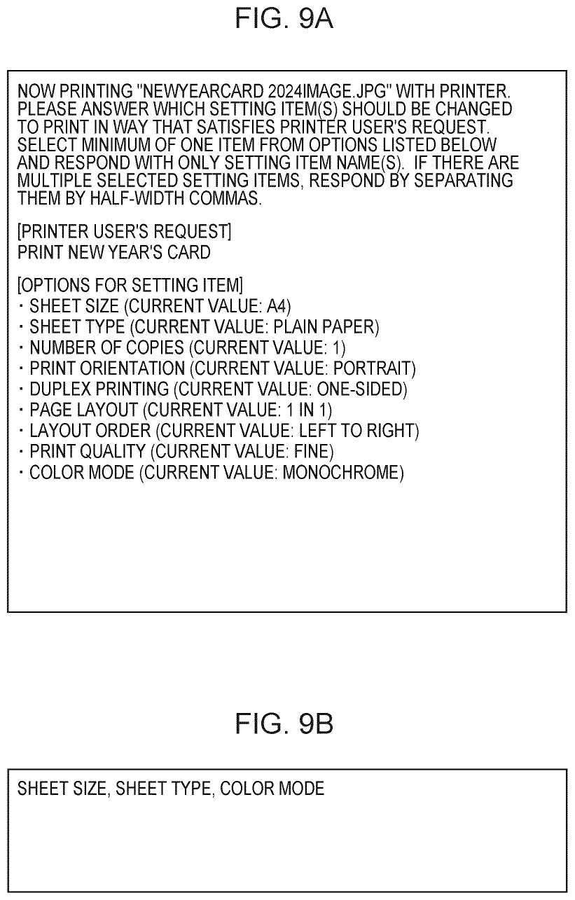

FIG. 9A illustrates an example of the printer-setting-item determination prompt M712 mentioned above. First, the text generative AI service 704 is given the role of providing appropriate printer settings in response to a request from the printer user 701. A message giving the role includes a file name of a file to be printed, and is information for causing the text generative AI service 704 to determine the print settings. A response method is limited to a sentence “make a list of . . . below”. The response format with respect to the text regenerative AI service 704 is also specified in detail. In FIG. 9A, the format is limited so as to be in the form of “item 1, item 2, item 3, . . . ”. This is to facilitate the implementation of text string interpretation of the printer-setting-item selection result M713 in the printer driver PC application 703 that receives the printer-setting-item selection result M713, which is a response from the text generative AI service 704.

FIG. 9B illustrates an example of the printer-setting-item selection result M713 transmitted from the text generative AI service 704 to the printer driver PC application 703. The setting items in the printer 702, such as “sheet size”, “sheet type”, and “color mode”, are messages separated by half-width commas and are in the response format specified in FIG. 9A.

### Example of Printer-Setting-Value Determination Prompt M714

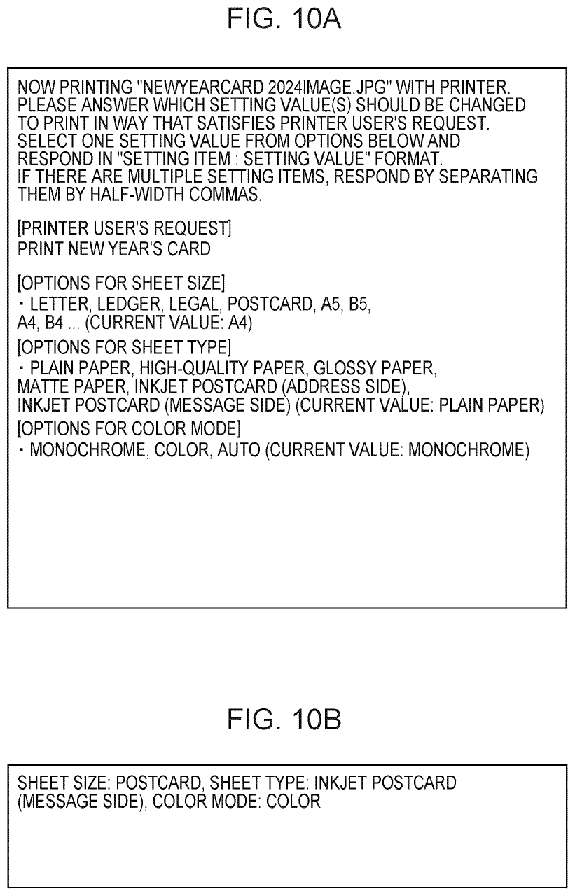

FIG. 10A illustrates an example of the printer-setting-value determination prompt M714 mentioned above. Similar to the printer-setting-item determination prompt M712, the text generative AI service 704 is given the role of providing appropriate printer settings in response to a request from the printer user 701, and provides a file name of a file to be printed. The response format is specified in detail. Moreover, FIG. 10A includes a list of printer setting values in the printer-setting-item selection result M713.

FIG. 10B illustrates an example of the printer-setting-value selection result M715 transmitted from the text generative AI service 704 to the printer driver PC application 703. A combination of printer setting values in printer setting items is indicated in the form of “setting item: setting value”, as in “sheet size: postcard”, and the setting items are separated by half-width commas.

### Outline of Second Embodiment

Accordingly, in this embodiment, even when an instruction from a user is an ambiguous colloquial expression, a printing operation desired by the user can be performed. Moreover, an inquiry to the text generative AI service 704 is set in two stages, namely, a printer setting item and a printer setting value with respect to the selected printer setting item. Accordingly, the text quantity can be reduced, as compared with when an inquiry is made at once by using all combinations of all printer setting items and printer setting values existing in the printer 702.

This embodiment can provide an electronic device capable of controlling a process based on an arbitrarily-expressed instruction in automatic processing based on a user instruction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro-processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206750, filed Nov. 27, 2024, which is hereby incorporated by reference herein in its entirety.

What is claimed is:

1. An electronic device that executes a process according to a setting value, the electronic device comprising:
one or more memories storing at least one program; and
one or more processors that execute the at least one program stored in the memory and cause the one or more processors to function as:
a first transmission unit that transmits, to an external device including a large language model, arbitrary text information received as an instruction input by a user and information about at least one setting item of the electronic device, the external device being configured to select the at least one setting item of the electronic device based on the arbitrary text information;
a first reception unit configured to receive the setting item from the external device;
a second transmission unit that transmits, to the large language model of the external device, information about the setting value that can be set in the received setting item, the external device being configured to determine the setting value for executing a process according to the instruction from the user;
a second reception unit configured to receive the setting value from the external device; and
a control unit that performs control by performing the process based on the setting value received by the second reception unit.

2. The electronic device according to claim 1,
wherein the first transmission unit transmits a first prompt for selecting the at least one setting item of the electronic device,
wherein the second transmission unit transmits a second prompt for determining the setting value for executing the process according to the instruction from the user,
wherein the first prompt includes the arbitrary text information and the information about the setting item of the electronic device, and
wherein the second prompt includes the information about the setting value that can be set in the setting item.

3. The electronic device according to claim 1, wherein at least one selection option for the setting item generated by the large language model includes all setting items included in the electronic device or one or more of the setting items.

4. The electronic device according to claim 1, wherein the information about the setting item of the electronic device includes a current setting value for the setting item.

5. The electronic device according to claim 1, wherein at least one selection option for the setting value generated by the large language model includes all setting values included in the electronic device or one or more of the setting values.

6. The electronic device according to claim 1, wherein the electronic device is an imaging device that has an imaging unit and the process executed using the setting value is an image capturing process.

7. The electronic device according to claim 1, wherein the electronic device is a printer and the process executed using the setting value is a printing process.

8. An electronic device that executes a process according to a setting value, the electronic device comprising:
one or more memories storing at least one program; and
one or more processors that execute the at least one program stored in the memory and cause the one or more processors to:
transmit information about a setting item of the electronic device to an information processing apparatus, the information about the setting item being transmitted based on receipt by, the electronic device, of arbitrary text information received as an instruction input by a user and information about at least one setting item of the electronic device;
select, by a large language model, the at least one setting item of the electronic device based on the arbitrary text information;
transmit the at least one setting item to the information processing apparatus; receive, from the information processing apparatus, information about a setting value that is settable in the setting item;
receive, from the information processing apparatus, a setting value that can be set for the setting item;
determine, using the large language model, the setting value for executing a process according to the instruction from the user;
transmit, to the information processing apparatus, the setting value determined using the large language model; and
execute the process, by the electronic device, based on the transmitted setting value.

9. An information processing apparatus comprising:
one or more memories storing at least one program; and
one or more processors that execute the at least one program stored in the memory and cause the one or more processors to:
transmit, to a large language model, arbitrary text information received as an instruction input by a user and information about at least one setting item of an electronic device that executes a process according to a setting value, the large language model trained to select the at least one setting item of an electronic device based on the arbitrary text information;
receive the setting item generated by the large language model;
transmit, to the large language model, information about a setting value settable in the received setting item, the large language model determining the setting value for executing a process, in the electronic device, according to the instruction from the user;
receive the setting value from the generated by the large language model; and
transmit the received setting value to the electronic device causing the electronic device to execute the process using the setting value.

10. A method for controlling an electronic device that executes a process according to a setting value, the method comprising:
transmitting, to a large language model, arbitrary text information received as an instruction input by a user and information about at least one setting item of the electronic device, the large language model trained to select at least one setting item of the electronic device based on the arbitrary text information;
receiving the setting item from the large language model;
transmitting, to the large language model, information about the setting value settable in the received setting item, the large language model trained to determine the setting value for executing a process according to the instruction from the user;
receiving the generated setting value; and
performing control to execute the process based on the received setting value.

11. A method for controlling an electronic device that executes a process according to a setting value, the method comprising:
transmitting information about a setting item of the electronic device to an information processing apparatus, the information about the setting item transmitted based on receipt by, the electronic device, of arbitrary text information received as an instruction input by a user and information about at least one setting item of the electronic device;
selecting, by a large language model, the at least one setting item of the electronic device based on the arbitrary text information;
transmitting the at least one setting item to the information processing apparatus;
receiving, from the information processing apparatus; information about a setting value that is settable in the setting item;
receiving, from the information processing apparatus, a setting value that can be set for the setting item;
determining, using the large language model, the setting value for executing a process according to the instruction from the user;
transmitting, to the information processing apparatus, the setting value determined using the large language model; and
executing the process, by the electronic device, based on the transmitted setting value.

12. A method for controlling an information processing apparatus, the method comprising:
transmitting, to a large language model, arbitrary text information received as an instruction input by a user and information about at least one setting item of an electronic device that executes a process according to a setting value, the large language model trained to select the at least one setting item of an electronic device based on the arbitrary text information;
receiving the setting item generated by the large language model;
transmitting, to the large language model, information about a setting value settable in the received setting item, the large language model determining the setting value for executing a process, in the electronic device, according to the instruction from the user;
receiving the setting value generated by the large language model; and
transmitting the received setting value to the electronic device causing the electronic device to execute the process using the setting value.

13. A non-transitory computer-readable storage medium storing a program for causing a computer to function as an electronic device that executes a process according to a setting value, the process comprising:
transmitting, to a large language model, arbitrary text information received as an instruction input by a user and information about at least one setting item of the electronic device, the large language model trained to select at least one setting item of the electronic device based on the arbitrary text information;
receiving the setting item from the large language model;
transmitting, to the large language model, information about the setting value settable in the received setting item, the large language model trained to determine the setting value for executing a process according to the instruction from the user;
receiving the generated setting value; and
performing control to execute the process based on the received setting value.
